(19) United States
(12) Patent Application Publication
(10) Pub. No.: US 2008/0030030 A1
(43) Pub. Date: Feb. 7, 2008

(54) Door lever and door lever assembly

(75) Inventors: Lien-Hsi Huang, Kaohsiung City (TW); Kuang-Chun Chiang, Kaohsiung County (TW)

Correspondence Address: TROXELL LAW OFFICE PLLC, SUITE 1404, 5205 LEESBURG PIKE, FALLS CHURCH, VA, 22041, US

(73) Assignee: Taiwan Fu Hsing Industrial Co., Ltd.

(21) Appl. No.: 11/497,413

(22) Filed: Aug. 2, 2006

(51) Int. Cl. E05B 3/00

(52) U.S. Cl. 292/348

(57) ABSTRACT

A door lever comprises a hollow handle portion and at least one filler. The hollow handle portion has a half-casing handle portion and a cylindrical portion formed by extending from one end of the half-casing handle portion. The cylindrical portion has at least one external recess portion and at least one internal protrusion corresponding to the external recess portion. The filler is filled into the external recess portion of the cylindrical portion for enhancing the structural strength of the internal protrusion of the cylindrical portion. The door lever further comprises a cover plate jointed to the half-casing handle portion of the hollow handle portion.

### FIELD OF THE INVENTION

The present invention relates to a door lever, and more particularly to a door lever that uses a filler filling into an external recess portion to enhance the structural strength of an internal protrusion corresponding to the external recess portion.

### BACKGROUND OF THE INVENTION

In general, a conventional door lever manufactured by casting comes with a heavy weight and a high cost. Therefore, a hollow assemble type handle as disclosed in R.O.C. Pat. Publication No. 00327911 is provided for improving the difficulties of manufacturing handles. However, the foregoing handle has a weak structure, so that the handle and its rotary components may become loosened easily after a long term of use, and finally the handle cannot be used anymore.

### SUMMARY

The primary object of this invention is to provide a door lever that comprises a hollow handle portion and at least one filler, and the hollow handle portion has a half-casing handle portion and a cylindrical portion, and the cylindrical portion is formed by extending from one end of the half-casing handle portion. The cylindrical portion has at least one external recess portion and at least one internal protrusion, wherein the external recess portion is corresponding to the internal protrusion and the filler is filled into the external recess portion of the cylindrical portion. The door lever further comprises a cover plate jointed to the half-casing handle portion of the hollow handle portion. The door lever of the present invention engages with a spindle and drives the spindle to rotate via the internal protrusion of the cylindrical portion. Besides lowering the level of difficulty of the manufacturing process, this invention also uses the filler filling into the external recess portion to enhance the structural strength of the internal protrusion corresponding to the external recess portion, and thus greatly enhancing the engaging strength between the door lever and the spindle.

The secondary object of this invention is to provide a door lever that further comprises a jointer formed between the filler and the external recess portion for enhancing the jointing strength of the filler and the external recess portion.

A further object of this invention is to provide a door lever that further comprises a cover layer formed on an external sidewall of the cylindrical portion and covered onto an exposed surface of the filler, so that the door lever has a smooth and level surface.

A door lever of the present invention comprises a hollow handle portion and at least one filler, and the hollow handle portion has a half-casing handle portion and a cylindrical portion, and the cylindrical portion is formed by extending from one end of the half-casing handle portion. The cylindrical portion has at least one external recess portion and at least one internal protrusion, wherein the external recess portion is corresponding to the internal protrusion and the filler is disposed at the external recess portion of the cylindrical portion. The door lever of this invention further comprises a cover plate jointed to the half-casing handle portion of the hollow handle portion.

A door lever assembly of the present invention includes a door lever and a spindle. The door lever comprises a hollow handle portion and at least one filler, and the hollow handle portion has a half-casing handle portion, a cylindrical portion integrally formed by extending from one end of the half-casing handle portion and a cover plate jointed to the half-casing handle portion. The cylindrical portion has at least one external recess portion and at least one internal protrusion, wherein the external recess portion is corresponding to the internal protrusion and the filler is filled into the external recess portion of the cylindrical portion. The spindle is inserted into the cylindrical portion of the hollow handle portion and engaged with the internal protrusion.

### DESCRIPTION OF THE DRAWINGS

FIGS. 1A to 1C are schematic views of a door lever in accordance with a preferred embodiment of the present invention.

FIG. 2A is a cross-sectional view of a hollow handle portion in accordance with a preferred embodiment of the present invention.

FIG. 2B is a cross-sectional view taken along line 2B-2B of FIG. 1B of the hollow handle portion with at least one filler formed thereon.

FIG. 2C is a cross-sectional view of a cover plate jointed to a hollow handle portion in accordance with a preferred embodiment of the present invention.

FIG. 3 is a cross-sectional view of a filler mixed with a jointer and filled into an external recess portion in accordance with another preferred embodiment of the present invention.

FIG. 4 is a cross-sectional view of a filler protruded from an external sidewall in accordance with another embodiment of the present invention.

FIG. 5 is a cross-sectional view of forming a cover layer in accordance with another embodiment of the present invention.

FIG. 6 is an exploded view of a door lever in accordance with another preferred embodiment of the present invention.

FIG. 7 is a three-dimensional view of a door lever assembly in accordance with another preferred embodiment of the present invention.

### DETAILED DESCRIPTION OF THE PRESENT INVENTION

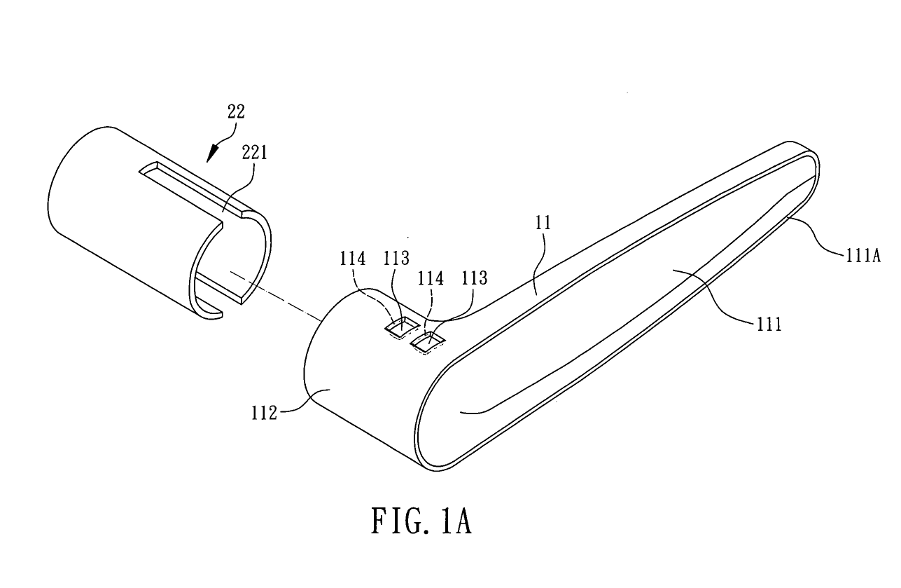

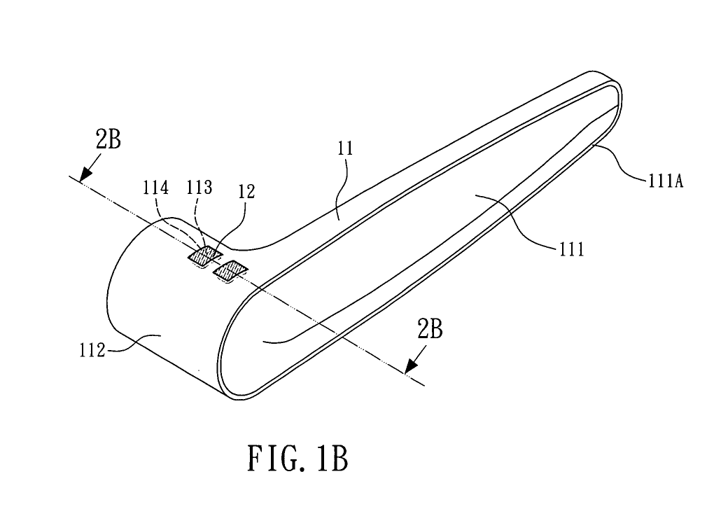

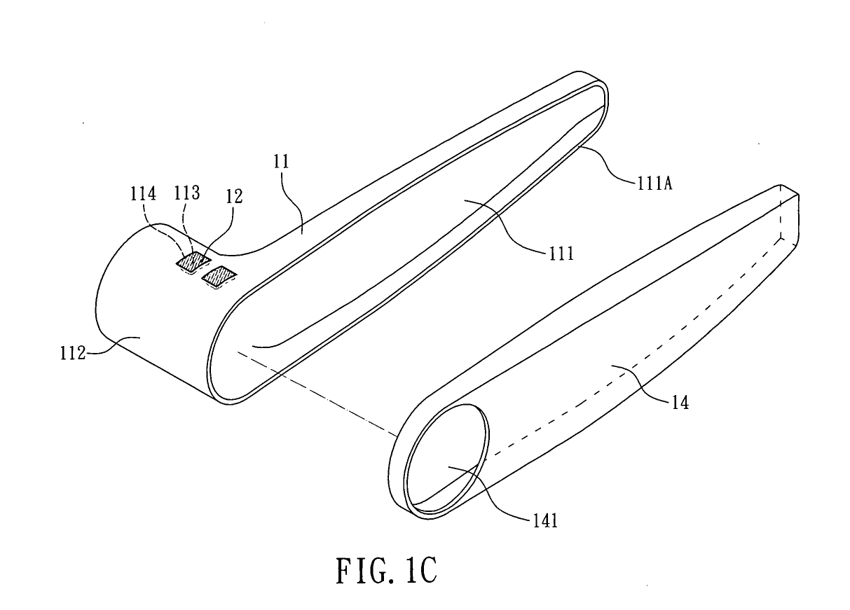

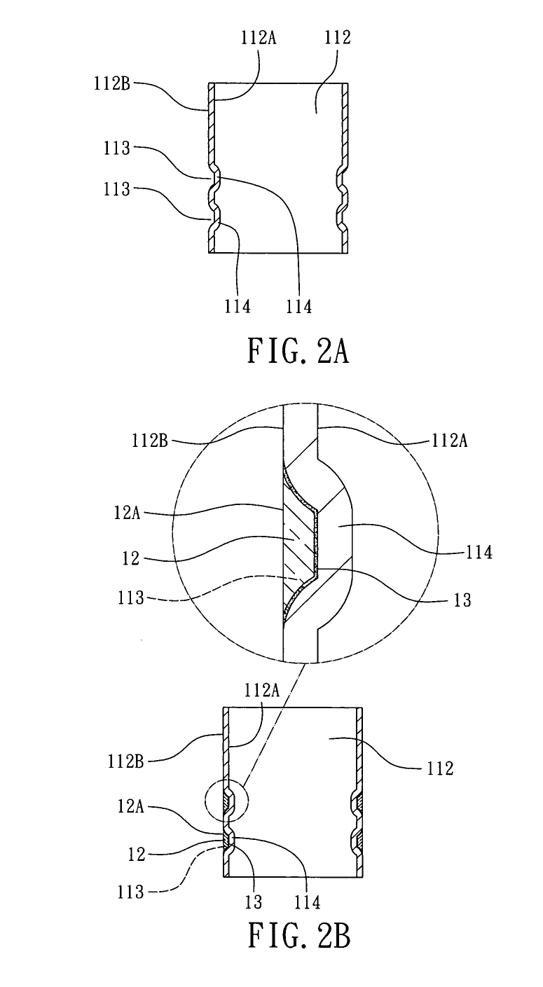

Referring to FIGS. 1A, 1C, 2A and 2C, a method for manufacturing a door lever 10 in accordance with a preferred embodiment of the present invention is disclosed. To begin with, providing a hollow handle portion 11 as shown in FIGS. 1A and 2A, the hollow handle portion 11 is formed by punching a metal sheet and has a half-casing handle portion 111 and a cylindrical portion 112, and the cylindrical portion 112 is formed by extending from one end of the half-casing handle portion 111, and the cylindrical portion 112 forms at least one external recess portion 113 and at least one internal protrusion 114, wherein the external recess portion 113 is corresponding to the internal protrusion 114.

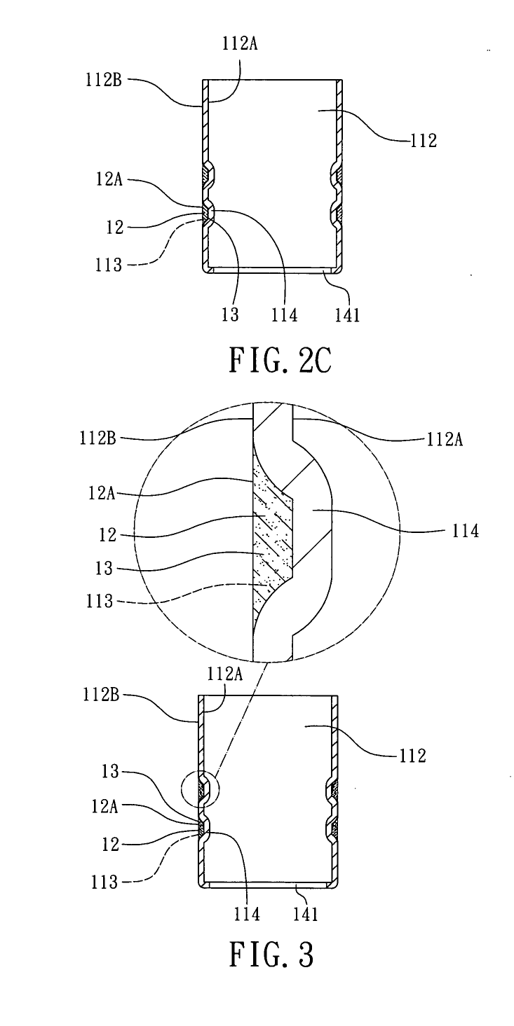

The internal protrusion 114 is formed on an internal sidewall 112A of the cylindrical portion 112, and the external recess portion 113 is formed on an external sidewall 112B of the cylindrical portion 112, wherein the external recess portion 113 and the internal protrusion 114 can be a square shape, a rectangular shape, a circular shape or another geometric shape. The door lever 10 of this invention engages with a latching slot 221 of a spindle 22 and drives the spindle 22 to rotate via the internal protrusion 114 of the cylindrical portion 112, such that the spindle 22 can rotate to drive a tongue of a lock to move forward and backward (not shown in the figures). Referring to FIGS. 1B, 2B and 3, forming at least one filler 12 at the external recess portion 113 of the cylindrical portion 112 for enhancing the structural strength of the internal protrusion 114 of the cylindrical portion 112, and the filler 12 has an exposed surface 12A. The exposed surface 12A of the filler 12 is preferably even with the external sidewall 112B of the cylindrical portion 112, so that the door lever 10 has a level surface, wherein the material of the filler 12 could be the same as the material of the hollow handle portion 11. In this embodiment, the door lever 10 further comprises a jointer 13 formed between the filler 12 and the external recess portion 113. Before the filler 12 is formed at the external recess portion 113, the jointer 13 is formed at the external recess portion 113 by spraying or coating in advance, so as to enhance the jointing strength of the filler 12 and the external recess portion 113, or in another embodiment as shown in FIG. 3, the filler 12 mixes with the jointer 13 in advance, and then fills the filler 12 into the external recess portion 113, so as to improve the jointing strength of the filler 12 and the external recess portion 113. Referring to FIGS. 1C and 2C, a cover plate 14 can be jointed to the half-casing handle portion 111 of the hollow handle portion 11, and the cover plate 14 is formed by punching a metal sheet, and the half-casing handle portion 111 has a surrounding flange 111A, and the cover plate 14 is jointed to the surrounding flange 111A of the half-casing handle portion 111 by way of soldering. In another embodiment, the cover plate 14 also has a surrounding flange (not shown in the figures), and the surrounding flange of the cover plate 14 is jointed to the half-casing handle portion 111 of the hollow handle portion 11. In this embodiment, the cover plate 14 has an opening 141 corresponding to the cylindrical portion 112 of the hollow handle portion 11 for accommodating a lock, a knob or a push button.

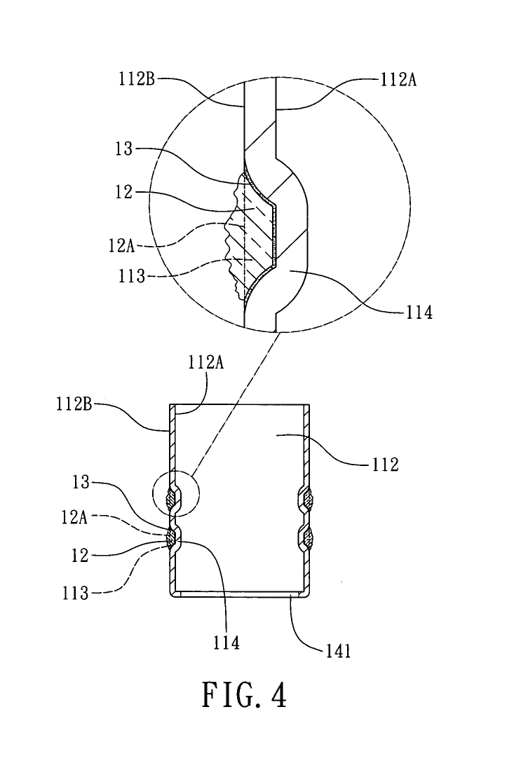

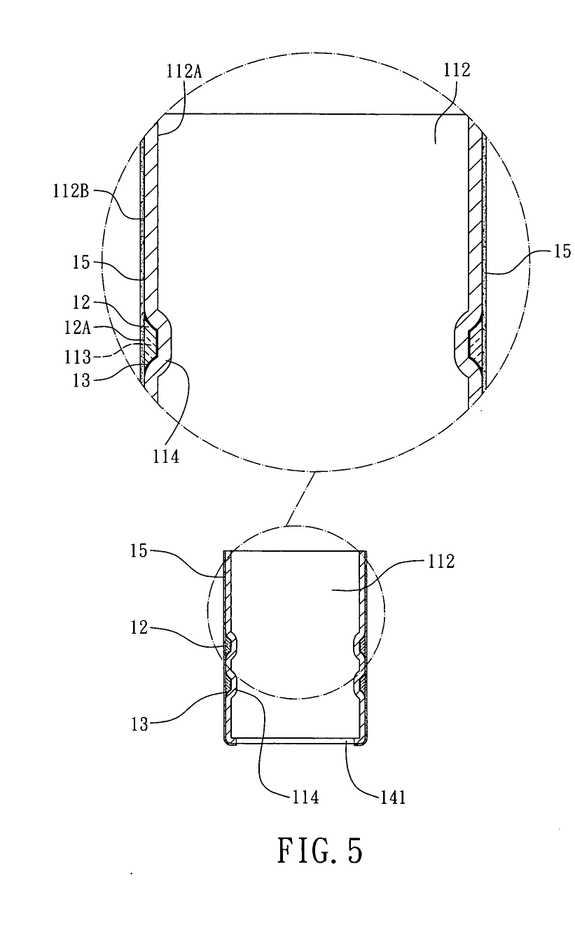

This embodiment further includes a grinding process as shown in FIG. 4. After the filler 12 is filled into the external recess portion 113, the grinding process can be used to remove any filler 12 protruded from the external sidewall 112B, so that the exposed surface 12A of the filler 12 is even with the external sidewall 112B. The present invention further comprises a process for forming the cover layer to enable the door lever 10 to have a smooth and level surface. Referring to FIG. 5, at least one cover layer 15 is formed on the external sidewall 112B of the cylindrical portion 112 and covered onto the exposed surface 12A of the filler 12. In this embodiment, the cover layer 15 could be an electroplated layer or a baked coating layer, and the material of the cover layer 15 could be the same as the material of the filler 12.

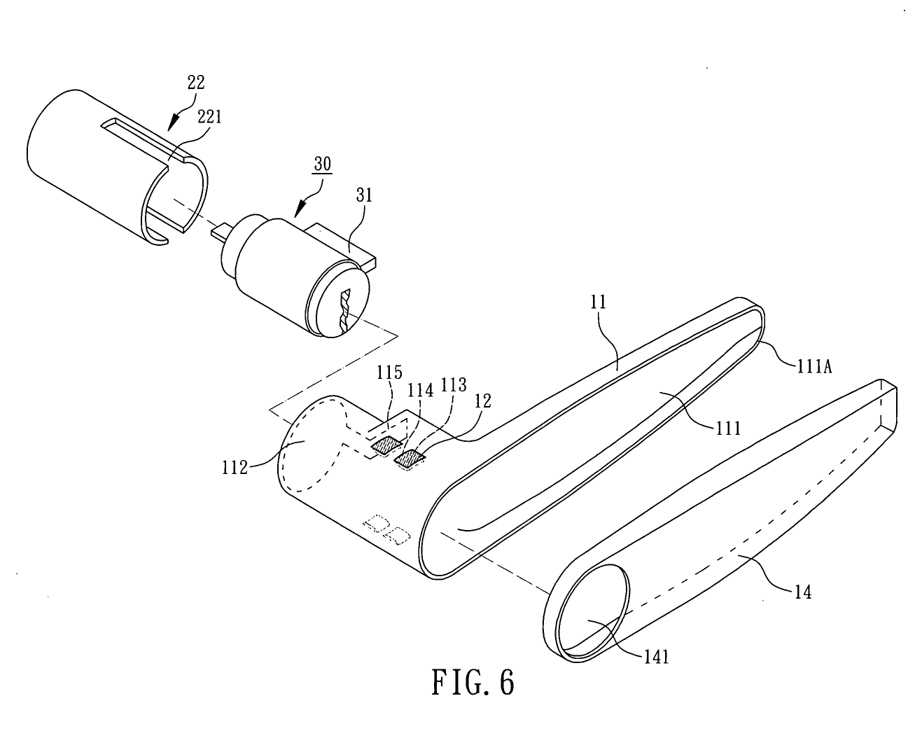

Referring to FIG. 6, the door lever 10 of the present invention connects with a lock 30, the lock 30 is installed in the spindle 22. The cylindrical portion 112 of the hollow handle portion 11 has a positioning slot 115 for embedding and positioning a positioning member 31 of the lock 30.

Referring to FIGS. 1C and 2C, a door lever 10 of the present invention comprises a hollow handle portion 11 and at least one filler 12, and the hollow handle portion 11 has a half-casing handle portion 111 and a cylindrical portion 112, and the cylindrical portion 112 is formed by extending from one end of the half-casing handle portion 111. The cylindrical portion 112 has an internal sidewall 112A, an external sidewall 112B, at least one external recess portion 113 formed on the external sidewall 112B and at least one internal protrusion 114 formed on the internal sidewall 112A, wherein the internal protrusion 114 is corresponding to the external recess portion 113. The filler 12 is filled into the external recess portion 113 of the cylindrical portion 112 for enhancing the structural strength of the internal protrusion 114 of the cylindrical portion 112, and the filler 12 has an exposed surface 12A that is substantially even with the external sidewall 112B of the cylindrical portion 112. The door lever 10 of this embodiment further comprises a jointer 13 (as shown in FIG. 2C) formed between the filler 12 and the external recess portion 113 for enhancing the jointing strength of the filler 12 and the external recess portion 113. The door lever 10 further comprises a cover plate 14 (as shown in FIG. 1C) jointed to the half-casing handle portion 111 of the hollow handle portion 11 by latching, soldering or adhering. Preferably, the door lever 10 further comprises a cover layer 15 (as shown in FIG. 5) formed on the external sidewall 112B of the cylindrical portion 112 and covered onto the exposed surface 12A of the filler 12 to enable the door lever 10 to have a smooth and level surface. The door lever 10 of the present invention engages with a latching slot 221 of a spindle 22 and drives the spindle 22 to rotate via the internal protrusion 114 of the cylindrical portion 112.

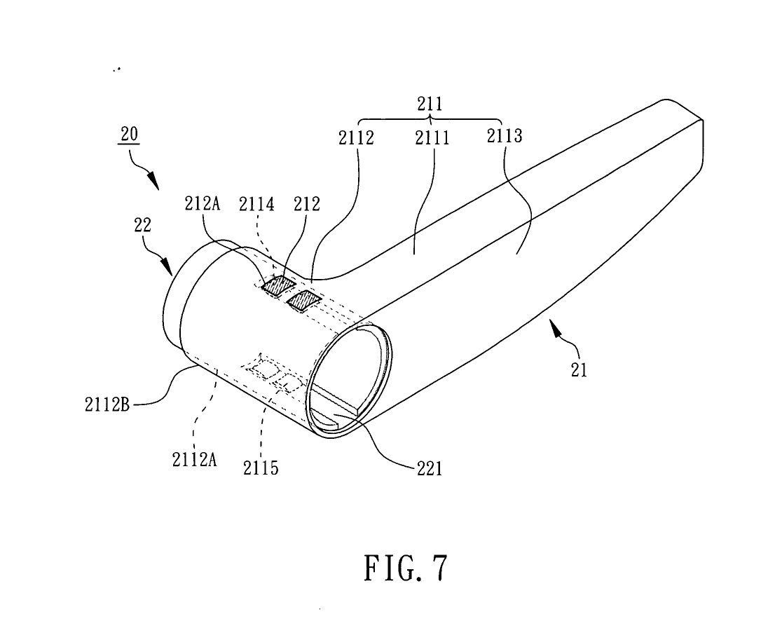

Referring to FIG. 7, a door lever assembly 20 of the present invention includes a door lever 21 and a spindle 22. The door lever 21 comprises a hollow handle portion 211 and at least one filler 212, and the hollow handle portion 211 has a half-casing handle portion 2111, a cylindrical portion 2112 integrally formed by extending from one end of the half-casing handle portion 2111 and a cover plate 2113 jointed to the half-casing handle portion 2111. The cylindrical portion 2112 has an internal sidewall 2112A, an external sidewall 2112B, at least one external recess portion 2114 formed on the external sidewall 2112B and at least one internal protrusion 2115 formed on the internal sidewall 2112A, wherein the internal protrusion 2115 is corresponding to the external recess portion 2114. The filler 212 is filled into the external recess portion 2114 of the cylindrical portion 2112 for enhancing the structural strength of the internal protrusion 2115 of the cylindrical portion 2112, and the filler 212 has an exposed surface 212A that is substantially even with the external sidewall 2112B of the cylindrical portion 2112. The spindle 22 is inserted into the cylindrical portion 2112 of the hollow handle portion 211 and has at least one latching slot 221 engaged with the internal protrusion 2115 to be drived by the door lever 21. In this embodiment, the door lever 21 of the door lever assembly 20 is the same as above-mentioned door lever 10 and the embodied details can refer to above descriptions without saying more than what is needed anymore.

While the present invention has been particularly illustrated and described in detail with respect to the preferred embodiments thereof, it will be clearly understood by those skilled in the art that various changed in form and details may be made without departing from the spirit and scope of the present invention.

What is claimed is:

1. A door lever, comprising:
a hollow handle portion having a half-casing handle portion and a cylindrical portion integrally formed by extending from one end of the half-casing handle portion, the cylindrical portion has an external sidewall, an internal sidewall, at least one external recess portion formed on the external sidewall and at least one internal protrusion formed on the internal sidewall, wherein the internal protrusion is corresponding to the external recess portion; and
at least one filler, filled into the external recess portion of the cylindrical portion and having an exposed surface.

2. The door lever of claim 1, wherein the material of the filler is the same as the material of the hollow handle portion.

3. The door lever of claim 1, further comprising a jointer formed between the filler and the external recess portion.

4. The door lever of claim 1, further comprising a jointer mixed with the filler.

5. The door lever of claim 1, further comprising a cover layer formed on the external sidewall of the cylindrical portion and covered onto the exposed surface of the filler.

6. The door lever of claim 5, wherein the cover layer is an electroplated layer or a baked coating layer.

7. The door lever of claim 1, further comprising a cover plate jointed to the half-casing handle portion of the hollow handle portion.

8. The door lever of claim 7, wherein the half-casing handle portion has a surrounding flange, and the cover plate is jointed to the surrounding flange of the half-casing handle portion.

9. The door lever of claim 7, wherein the cover plate has an opening corresponding to the cylindrical portion of the hollow handle portion.

10. A door lever assembly, including:
a door lever, comprising:
a hollow handle portion having a half-casing handle portion, a cylindrical portion integrally formed by extending from one end of the half-casing handle portion and a cover plate jointed to the half-casing handle portion, the cylindrical portion has an external sidewall, an internal sidewall, at least one external recess portion formed on the external sidewall and at least one internal protrusion formed on the internal sidewall, wherein the internal protrusion is corresponding to the external recess portion; and
at least one filler, filled into the external recess portion of the cylindrical portion and having an exposed surface; and
a spindle, inserted into the cylindrical portion of the hollow handle portion and engaged with the internal protrusion.

11. The door lever assembly of claim 10, wherein the material of the filler is the same as the material of the hollow handle portion.

12. The door lever assembly of claim 10, wherein the door lever further comprising a jointer formed between the filler and the external recess portion.

13. The door lever assembly of claim 10, wherein the door lever further comprising a jointer mixed with the filler.

14. The door lever assembly of claim 10, wherein the door lever further comprising a cover layer formed on the external sidewall of the cylindrical portion and covered onto the exposed surface of the filler.

15. The door lever assembly of claim 14, wherein the cover layer is an electroplated layer or a baked coating layer.

16. The door lever assembly of claim 10, wherein the half-casing handle portion has a surrounding flange, and the cover plate is jointed to the surrounding flange of the half-casing handle portion.

17. The door lever assembly of claim 10, wherein the cover plate has an opening corresponding to the cylindrical portion.

18. The door lever assembly of claim 10, wherein the spindle has at least one latching slot engaged with the internal protrusion.
